(19) United States
(12) Patent Application Publication
(10) Pub. No.: US 2004/0040572 A1
(43) Pub. Date: Mar. 4, 2004

(54) Tongue scraper/dental flosser

(76) Inventor: Ingram S. Chodorow, Rancho Santa Fe, CA (US)

Correspondence Address: J. David Dainow, Amster, Rothstein & Ebenstein, 90 Park Avenue, New York, NY, 10016, US

(21) Appl. No.: 10/408,359

(22) Filed: Apr. 7, 2003

Related U.S. Application Data
(60) Provisional application No. 60/371,000, filed on Apr. 8, 2002.

(51) Int. Cl. A61C 15/00

(52) U.S. Cl. 132/323

(57) ABSTRACT

This invention is a combination dental flosser and tongue scraper in a single injection molded hand-held disposable device. The tongue scraper portion serves as a handle for the dental flosser for the flosser portion, and the dental flosser portion serves as a handle for the tongue scraper portion. The dental flosser and tongue scraper components serve as oral hygiene elements for cleaning surfaces of the teeth and between the teeth and cleaning surfaces of the tongue respectively.

This application claims benefit of the file date of applicant's co-pending provisional application No. 60,371,000 filed Apr. 8, 2002.

### BACKGROUND OF THE INVENTION

1. Field of the Invention

This invention is in the field of dental hygiene devices, including dental flossers and tongue scrapers.

2. Relevant Prior Art

Relevant prior art includes dental flosser patents of applicant incorporated herein by reference U.S. Pat. Nos. D401,701, D291,412, 4,807,752, D250,214, D244,609, D244,376, 4,006,750, 4,016,892, 5,538,023, 6,065,479, 5,911,229, D410,115, 5,692,531, 6,085,760, 5,829,458, 5,086,792, 5,538,023, D408,589, D443,113 and D455,232. Relevant prior art tongue scraper patents include U.S. Pat. Nos. 5,388,600, 4,079,478, 4,455,704, 4,488,327, 4,610,043, 4,638,521, 5,005,246, 5,061,272, 5,217,475, 5,226,197, 5,569,278, 5,779,475, 5,868,769, 5,893,860, 5,910,151, 6,099,540 and 6,152,939.

Known oral hygiene devices include dental flossers, tongue scrapers and of course the ubiquitous toothbrushes. U.S. Pat. Nos. 6,273,719, 4,488,327 and 5,005,246 each disclose an oral hygiene implement which provides toothbrush and tongue scraper components at opposite ends of a central part; however, in each of these implements the components have a traditional bulky shape and corresponding complexity and expense of manufacturing.

U.S. Pat. Nos. 5,217,475, 5,779,475 and 5,893,860 for example, disclose tongue scrapers, which are large, bulky and expensive implements. The other prior art references cited herein disclose a large variety of oral hygiene implements.

It is an object of the present invention to provide a combination tongue scraper and dental flosser that is extremely compact, effective and easy to use, and is highly economical to manufacture. If the latter objective is not achieved, then it is impractical to commercialize this kind of product, because very high volume and very low cost are prerequisites.

It is thus a further object to provide a design which can be readily injection molded in a multicavity mold.

It is a still further object to design this oral hygiene implement so that the multicavity mold will be as small, efficient and inexpensive as possible, while the implement itself is comfortable, easy to use and attractive.

### SUMMARY OF THE INVENTION

This invention is a oral hygiene device which combines a dental flosser with a tongue scraper into a single, unitary, disposable device, where the flosser portion serves as part of the handle for the tongue scraper and the tongue scraper portion serves as part of the handle for the flosser. The objects described above have been achieved in a new injection molded plastic design that is essentially flat and thus extremely easy and inexpensive to mold. A further aspect of the new design is the use of the dental flosser component as a portion of the handle for the tongue scraper, and use of the tongue scraper component as a portion of the handle for the flosser. This achieves compactness, reduces overall size, and provides a novel and highly esthetic appearance.

The tongue scraper portion is an oval loop element having beveled or flared inner edges that rise above the surface or plane of the loop. This oval form has the advantage of providing scraping surfaces on the complete periphery no matter which direction the scraper is moved. The scraping surfaces are the top and bottom edges of the inner wall surface of the oval. These edges are sufficiently sharp and shaped to provide adequate scraping without damaging or hurting the tongue surface.

This product is preferably molded by injection molding apparatus which is known as disclosed in the prior art cited herein where the molded plastic and dental floss are selected from materials described in various of said prior art patents. The embodiment seen as FIGS. 1-5 differs from the embodiment of FIGS. 6-10 in that the former has a sharper taper along the oval scraping edge, namely at the oval edge of the scraper. Outward of this scraping edge is a smooth bullnose edge to avoid hurting or irritating the tongue or any other part of the mouth, lips or gums. The flosser portion has dual strands of floss situated parallel and spaced apart and molded ‘in situ’ when the product is made, but single strands are also possible.

This particular product is unique in that its shape and configuration not only provide a set of ideal handles for the two functions of scraping and flossing, but allow optimum use of mold space to produce the maximum number of units in minimum mold size and minimum mold cycle time, thus a most economical molding operation. More specifically, this product design and resulting mold design allow the products to be positioned and aligned in a manner where they fit and conform to each other so closely that there is essentially no wasted space or wasted plastic. Furthermore, the tongue scraper shape is ideal as a handle for the flosser and the flosser shape is ideal as a handle for the tongue scraper. Finally, the overall shape of this combination article is new, modem and attractive.

### DESCRIPTION OF THE DRAWINGS

FIG. 1 is a top, rear and right side perspective view of a first embodiment of a Dental Flosser/Tongue Scraper Combination showing my new design;

FIG. 2 is a front, bottom left side perspective view thereof;

FIG. 3. is a top plan view thereof;

FIG. 4. is a left side view thereof;

FIG. 5 is a front view partially broken away taken along the lines 5-5 of FIG. 4.

FIG. 6 is a top, rear and right side perspective view of a second embodiment of a Dental Flosser/Tongue Scraper Combination showing my new design;

FIG. 7 is a front, bottom left side perspective view thereof;

FIG. 8. is a top plan view thereof;

FIG. 9. is a left side view thereof;

FIG. 10 is a front view partially broken away taken along the lines 10-10 of FIG. 9; and

FIG. 11 shows schematically an injection mold for molding multiple parts.

### DETAILED DESCRIPTION OF THE PREFERRED EMBODIMENTS

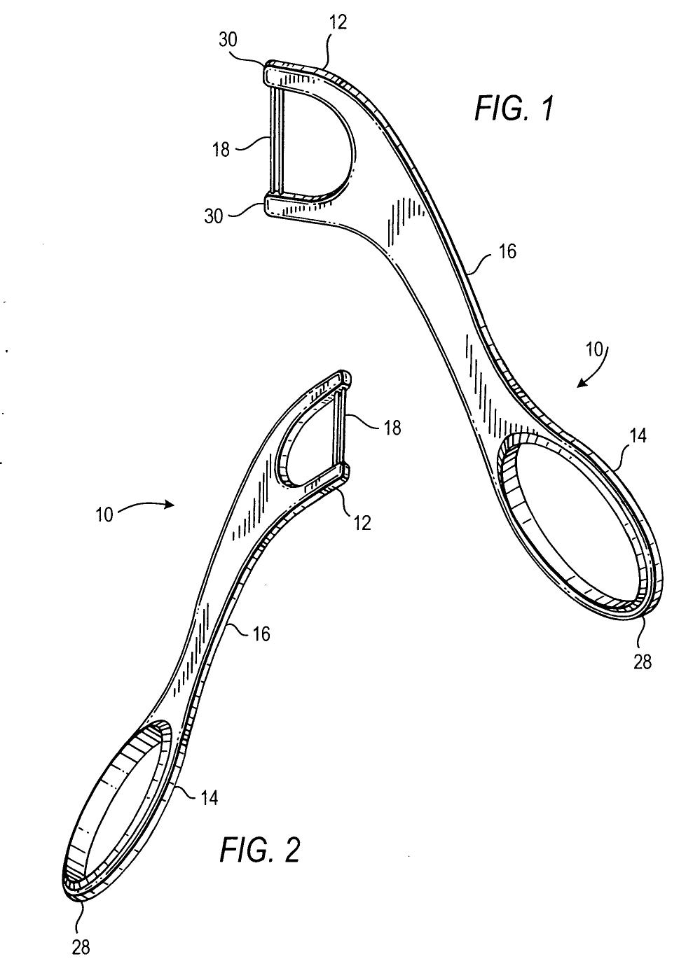

FIGS. 1-5 illustrate a first embodiment of the new combination tongue scraper and dental flosser device 10 which includes flosser portion 12 at one end and tongue scraper portion 14 at the opposite end. Between these opposite ends is a body portion 16 which is common to both the flosser and tongue scraper portions.

The tongue scraper portion 14 in combination with body portion 16 comprises a handle for the flosser portion 12, and similarly the body portion 16 in combination with the flosser portion 12 serves as a handle for the tongue scraper portion 14. The entire device 10 is injection molded of plastic as a single integral unit. As described in greater detail below, the strands of floss 18 according to a preferred method of manufacture are molded ‘in situ’ onto the flosser at the time a plurality of complete devices are injection molded. It is optional whether the floss consists of a single strand or of a pair of parallel and spaced apart strands 18 as seen in FIGS. 1 and 2, or consists of even more than two strands.

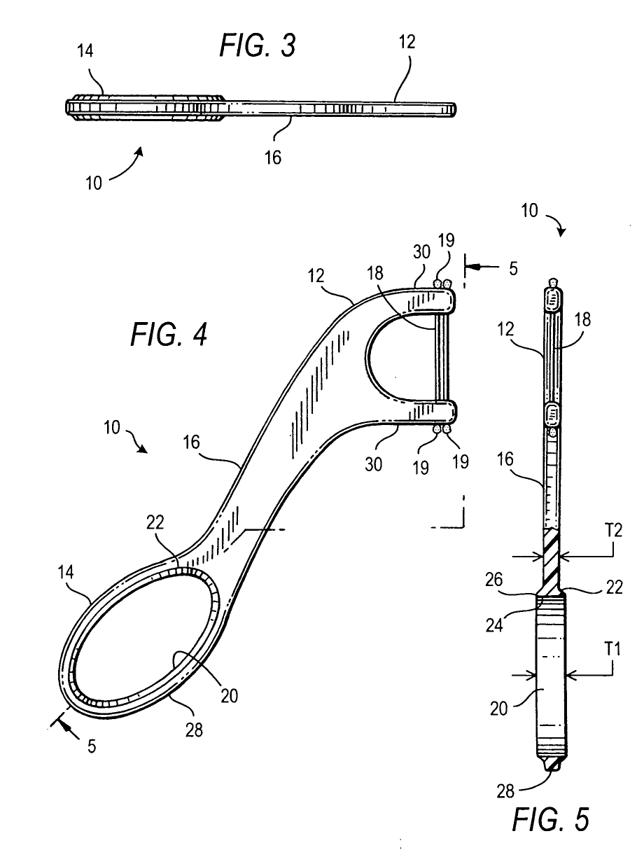

This device as seen in FIGS. 1 and 2 and also in FIGS. 3-5 is a generally planar or flat thin article where the flosser part defines a U shape and the tongue scraper part 14 is formed by an oval rim 20. As seen in FIG. 5 which is a sectional view taken through said oval 20, the thickness of the inner surface indicated by reference T1 is greater than the thickness T2 of the body portion 16. The height of the scraping edge may be in the range 0.5 mm to 2 mm or other as desired. Further as seen in FIG. 5 the outer surface 22 of the oval is tapered, whereas the inner surface 24 is a relatively straight wall so as to produce an edge 26 which is effectively a curved scraping blade. Edge 26 obviously extends around the entire periphery of the inside surface of the oval. The outer edge of the tongue scraper 14 is formed as a rounded bull nose 28 which is smooth to avoid scratching or irritating any part of the mouth while the tongue scraper is being used.

As further seen in FIG. 5, the strands of dental floss 18 are located centrally in the plane of the flosser 12 and extend with their ends embedded in the arms 30 of the flosser component. As shown in FIG. 4 the floss has its ends extending slightly out of the flosser arms and formed into small beads 19. These beads have diameter slightly greater than that of the original strands, with the result that the beads prevent the floss ends from being pulled out of flosser arms 30 when the floss is pulled during use. This preferred structure of beads is to anchor the floss but not mandatory and is shown only in FIG. 4.

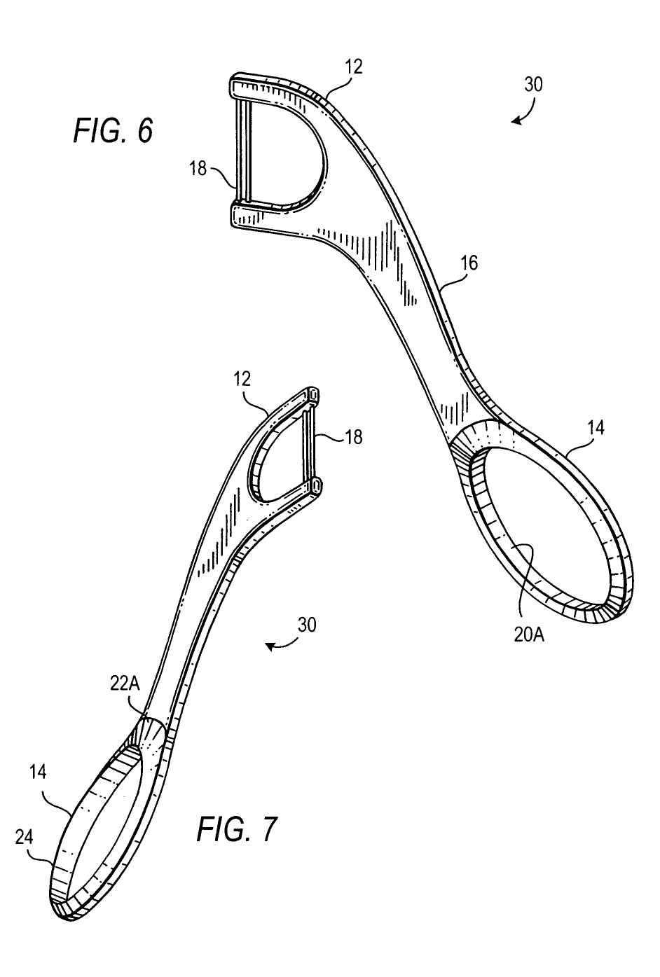

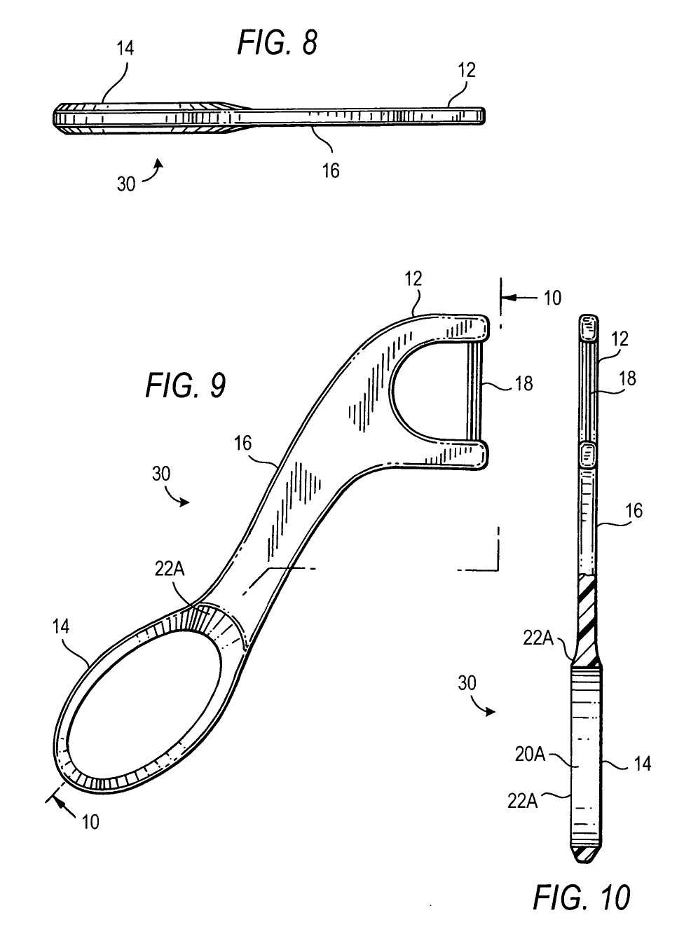

FIGS. 6-10 illustrate a second embodiment that is substantially similar to the first embodiment and for which the same reference numbers are used for parts which are essentially the same in both embodiments. Accordingly, the combination tongue scraper and dental flosser 30 of FIGS. 6-10 has a flosser part 12, a tongue scraper part 14, a body part 16 and dental floss 18.

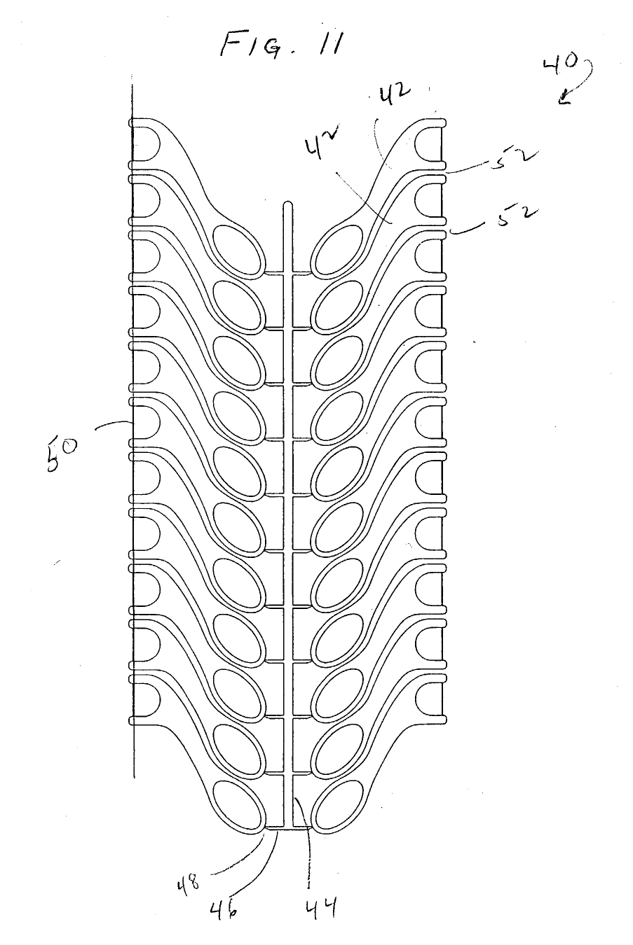

The principle difference between these embodiments is in a portion of the tongue scraper where taper 22A in FIG. 10 is at a lower angle than taper 22 in FIG. 5. This slower or milder taper 22A is also seen in FIG. 7 and 9 which produces a somewhat different look; however, the tongue scraper 30 has essentially the same scraping edge 24 at the top and bottom of the inner wall 24 of oval 20A, as seen in FIG. 6 and 10.

The preferred method of manufacturing the articles of this invention is known from various of applicant's own patents cited above in the sub-section entitled relevant prior art. More particularly, cavities are formed in a multi-cavity mold. These cavities are oriented in such a way that a strand of dental floss can be positioned to span all the arms of all the dental floss holder components at once while the strand is extended in one continuous straight line. While FIG. 11 does not show a mold, this Figure does illustrate a rack of injection molded parts that have been removed from such a mold. Accordingly, the rack 40 of a plurality of devices 42 includes a central strip of plastic 44 and runners 46 by which these devices were formed. At a subsequent stage of manufacture the various devices are each separated by being broken at the gate 48 from the runner 46 and central plastic stem 44.

The continuous strand of floss 50 is severed at points 52 between each individual dental floss components. The severing is done as a separate stage, usually with heat or flame apparatus that leaves a tiny segment of the floss extending out of the arm and coalesced into a bead which had diameter greater than that of the original strand of floss and which then acts as a blocking element to prevent the floss from being pulled through the arms, if the floss is severely strained during use.

Further, as seen in FIG. 11, the oval shape of these devices and the arrangement and orientation of one relative to the other is such that they line up in an extremely compact formation in an absolute minimum of space and thus in a smaller mold. Each device has a gentle S shape which is not only esthetically pleasing, but is functionally advantageous because it allows the handle formed by the body 16 plus one end component to easily and comfortably fit into a user's palm while the remaining end, whether it be the flosser 12 or the tongue scraper 14, extends at an angle which is particularly useful and convenient for a user. As seen in FIG. 11, a typical device has the flosser extending generally horizontally, while the handle extends at an angle downward therefrom, and the tongue scraper extends at a slightly different angle from the axis of the body portion 16 of the handle. The intersection of the flosser and central part axes may vary from 00 to 900.

Although this invention has been described with a certain degree of particularity, it is to be understood that the present disclosure has been made only by way of illustration and that numerous changes in the details of this article may be applied without departing from the spirit and scope of this invention as defined by the claims herein.

1. An oral hygiene device comprising:
a—a central body part having opposite ends,
b—a dental flosser part at one of said ends,
c—a tongue scraper part at the outer of said ends,
d—said three parts being integrally formed as a unitary injection molded article, whereby said
e—central body part and said dental flosser part from a handle for said tongue scraper part and said central body part and said tongue scraper part form a handle for said dental flosser part,
f—said three parts are each thin and flat and all lie in a common plane,
g—said dental flosser has two spaced apart arms and at least one strand of dental floss spanning and fixed to said arms, and
h—said tongue scraper comprises a rim whose inner wall defines a closed oval opening, said wall extending transversely above and below said plane of said tongue scraper terminating as top and bottom edges that serve as tongue scraping elements.

2. A device according to claim 1 wherein said dental floss extends in a generally straight line defining a first axis, said central body part is elongated defining therein a second axis, where said first and second axes have orientation of one relative to each other ranging from parallel to perpendicular.

3. A device according to claim 2 wherein said first and second axes intersect at an angle in the range of 0° to 90°.

4. A device according to claim 1 wherein said tongue scraper, cental body part and dental flosser parts together define a generally elongated S-shape.

5. A device according to claim 1 wherein said inner edge of said rim extends above and below said plane by an amount in the range of 0.5 mm to 2 mm.

6. A device according to claim 1 wherein said dental floss part has a pair of said strands of dental floss, said strands being generally parallel to each other and slightly spaced apart.

7. A device according to claim 1 wherein said wall in sectional view from top bottom is generally flat.

8. A device according to claim 2 wherein said tongue scraper oval has a longitudinal central axis, designated as third axis, said dental flosser part has width defined by the distance along said first axis between the outer surfaces of said spaced apart arms, and said tongue scraper has a diameter perpendicular to said third axis that has length essentially the same as said width of said dental flosser.

9. A device according to claim 8 wherein said central body part has width that is less than said width of said dental flosser part.

10. A device according to claim 1 wherein said dental floss and said tongue scraper parts have generally similar widths, and said central body part has width less than that of said dental flosser and tongue scraper parts.

11. An oral hygiene device comprising:
a—a central body part having opposite ends,
b—a dental flosser part at one of said ends,
c—a tongue scraper part at the outer of said ends,
d—said three parts being integrally formed as a unitary injection molded article, whereby said
e—central body part and said dental flosser part from a handle for said tongue scraper part and said central body part and said tongue scraper part form a handle for said dental flosser part,
f—said three parts are each thin and flat and all lie in a common plane,
g—said dental flosser has two spaced apart arms and at least one strand of dental floss spanning and fixed to said arms, and
h—said tongue scraper comprises a rim whose inner wall defines a oval opening, said wall extending transversely above and below said plane of said tongue scraper terminating as top and bottom edges that serve as tongue scraping elements.
